(19) United States
(12) Patent Application Publication
(10) Pub. No.: US 2026/0164501 A1
(43) Pub. Date: Jun. 11, 2026

(54) ENABLING (RE) TRANSMISSIONS WITH NETWORK DISCONTINUOUS RECEPTION/ DISCONTINUOUS TRANSMISSION

(71) Applicant: Nokia Technologies Oy, Espoo (FI)

(72) Inventors: Samuli Heikki TURTINEN, Ii (FI); Chunli WU, Beijing (CN); Jarkko Tuomo KOSKELA, Oulu (FI)

(73) Assignee: Nokia Technologies Oy, Espoo (FI)

(21) Appl. No.: 19/125,866

(22) PCT Filed: Nov. 3, 2022
(86) PCT No.: PCT/CN2022/129681

§ 371 Date: Apr. 30, 2025

(51) Int. Cl. H04W 76/28; H04W 72/115; H04W 72/1263

(52) U.S. Cl. CPC H04W 76/28; H04W 72/115; H04W 72/1263

(57) ABSTRACT

Embodiments of the present disclosure relate to devices, methods, apparatuses and computer readable storage media enabling (re) transmissions with network Discontinuous Reception (DRX) /Discontinuous Transmission (DTX). The method comprises: obtaining, at a terminal device, information indicative of a DTX pattern and/or a DRX pattern of a network node; and determining that at least one of scheduling information that is associated with between the terminal device and the network node has high priority or an indication indicates whether the DTX pattern and/or the DRX pattern is to be followed or applied by the terminal device to monitor a downlink control channel associated with the data communication, from the network node; and monitoring, based on the determination, the downlink control channel regardless of the DTX pattern and/or the DRX pattern of the network node.

### FIELD

Various example embodiments of the present disclosure generally relate to the field of telecommunication and in particular, to methods, devices, apparatuses and computer readable storage medium for enabling (re)transmissions with network Discontinuous Reception (DRX)/Discontinuous Transmission (DTX).

### BACKGROUND

A study item for network energy savings for NR has been discussed. Especially, a cell level DRX/DTX is to be used for the network energy savings and pattern associated with the DRX/DTX may be informed to the UEs with a dedicated or common signalling.

### SUMMARY

In general, example embodiments of the present disclosure provide a solution of enabling (re)transmissions with DRX/DTX.

In a first aspect of the present disclosure, there is provided an apparatus. The apparatus comprises at least one processor; and at least one memory storing instructions that, when executed by the at least one processor, cause the apparatus at least to obtain information indicative of a DTX pattern and/or a DRX pattern of a network node; and determine that at least one of scheduling information that is associated with between the apparatus and the network node has high priority or an indication indicates whether the DTX pattern and/or the DRX pattern is to be followed or applied by the apparatus to monitor a downlink control channel associated with the data communication, from the network node; and monitor, based on the determination, the downlink control channel regardless of the DTX pattern and/or the DRX pattern of the network node.

In a second aspect of the present disclosure, there is provided an apparatus. The apparatus comprises at least one processor; and at least one memory storing instructions that, when executed by the at least one processor, cause the apparatus at least to transmit, to a terminal device, information indicative of a DTX pattern of and/or a DRX pattern of the apparatus; and transmit, to the terminal device, an indication indicates whether the DTX pattern and/or the DRX pattern is to be followed or applied by the terminal device to monitor a downlink control channel associated with the data communication, from the apparatus.

In a third aspect of the present disclosure, there is provided a method. The method comprises: obtaining, by a terminal device, information indicative of a DTX pattern and/or a DRX pattern of a network node; and determining, by the terminal device, that at least one of scheduling information that is associated with between the terminal device and the network node has high priority or an indication indicates whether the DTX pattern and/or the DRX pattern is to be followed or applied by the terminal device to monitor a downlink control channel associated with the data communication, from the network node; and monitoring, by the terminal device and based on the determination, the downlink control channel regardless of the DTX pattern and/or the DRX pattern of the network node.

In a fourth aspect of the present disclosure, there is provided a method. The method comprises: transmitting, by a network node to a terminal device, information indicative of a DTX pattern of and/or a DRX pattern of the network node; and transmitting, to the terminal device, an indication indicates whether the DTX pattern and/or the DRX pattern is to be followed or applied by the terminal device to monitor a downlink control channel associated with the data communication, from the network node.

In a fifth aspect of the present disclosure, there is provided an apparatus. The apparatus comprises means for obtaining information indicative of a DTX pattern and/or a DRX pattern of a network node; and means for determining that at least one of scheduling information that is associated with between the apparatus and the network node has high priority or an indication indicates whether the DTX pattern and/or the DRX pattern is to be followed or applied by the apparatus to monitor a downlink control channel associated with the data communication, from the network node; and means for monitoring, based on the determination, the downlink control channel regardless of the DTX pattern and/or the DRX pattern of the network node.

In a sixth aspect of the present disclosure, there is provided an apparatus. The apparatus comprises means for transmitting, to a terminal device, information indicative of a DTX pattern of and/or a DRX pattern of the apparatus; and means for transmitting, to the terminal device, an indication indicates whether the DTX pattern and/or the DRX pattern is to be followed or applied by the terminal device to monitor a downlink control channel associated with the data communication, from the apparatus.

In a seventh aspect of the present disclosure, there is provided a computer readable medium. The computer readable medium comprising instructions which, when executed by an apparatus, cause the apparatus to perform at least the method according to the third aspect or the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example signaling diagram of enabling (re)transmissions with DRX/DTX according to some example embodiments of the present disclosure;

FIG. 3 illustrates a flowchart of a method implemented at a terminal device according to some example embodiments of the present disclosure;

FIG. 4 illustrates a flowchart of a method implemented at a network node according to some example embodiments of the present disclosure;

FIG. 5 illustrates a simplified block diagram of a device that is suitable for implementing example embodiments of the present disclosure; and

FIG. 6 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network node, or other computing or network node.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network node” refers to a node in a communication network via which a terminal device accesses the network and receives services therefrom. The network node may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network node such as a satellite network node, a low earth orbit (LEO) satellite and a geosynchronous earth orbit (GEO) satellite, an aircraft network node, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network node, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

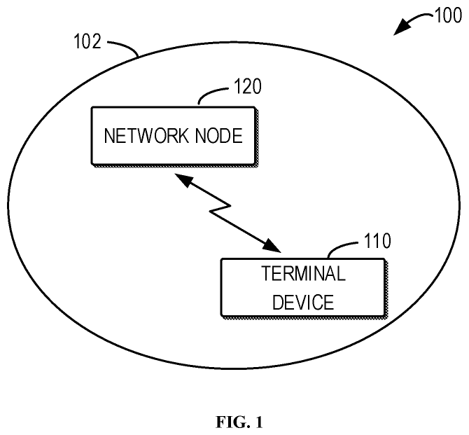

FIG. 1 shows an example communication network 100 in which embodiments of the present disclosure may be implemented. As shown in FIG. 1, the communication network 100 may comprise a terminal device 110. Hereinafter the terminal device 110 may also be referred to as a UE or an apparatus.

The communication network 100 may further comprise a network node 120. Hereinafter the network node 120 may also be referred to as a gNB. The terminal device 110 may communicate with the network node 120.

It is to be understood that the number of network nodes and terminal devices shown in FIG. 1 is given for the purpose of illustration without suggesting any limitations. The communication network 100 may include any suitable number of network nodes and terminal devices.

In some example embodiments, links from the network node 120 to the terminal device 110 may be referred to as a downlink (DL), while links from the terminal device 110 to the network node 120 may be referred to as an uplink (UL). In DL, the network node 120 is a transmitting (TX) device (or a transmitter) and the terminal device 110 is a receiving (RX) device (or receiver). In UL, the terminal device 110 is a TX device (or transmitter) and the network node 120 is a RX device (or a receiver).

Communications in the communication environment 100 may be implemented according to any proper communication protocol(s), includes, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As described above, the study item for network energy savings for NR has been discussed and developed. One aspect for this study item may focus on how to achieve more efficient operation dynamically and/or semi-statically and finer granularity adaptation of transmissions and/or receptions in one or more of network energy saving techniques in time, frequency, spatial, and power domains, with potential support/feedback from UE, and potential UE assistance information.

Furthermore, a cell level DTX/DRX may be applied to the UE, at least for the UE in RRC_CONNECTED, RRC_IDLE, or RRC_INACTIVE state. For example, a periodic Cell DTX/DRX may be configured by the gNB via Radio Resource control (RRC) Signalling. Furthermore, the pattern or mode associated with the DTX/DRX of the gNB may also be informed to the UEs with dedicated or common signalling. The cell level DTX/DRX may be specific to a cell that serves a terminal device, specific to a beam of a cell, specific to a cell group that comprises of multiple cells, of specific to a UE. The dedicated signaling may be signaling to a specific UE, for example, via RRC signaling, MAC signaling, or L1 signaling. The common signaling may be signaling to multiple UEs (e.g., UEs within a coverage area of a specific cell), for example, via system information broadcast.

In some scenarios, when an UL transmission or a DL transmission happens, it may not be successfully received by the receiver and will require re-transmission (either by the UE in UL or the network node in DL). When the network node is in energy saving mode, scheduling opportunities for the re-transmissions may be limited and with DRX functionality configured and applied, scheduling re-transmission may be delayed until next occasion of drx-onDurationTimer starts, which may incur unacceptable delay for some services.

In this situation, it is to be discussed whether/how to align UE DRX with network DTX, including UE transmission/reception behaviour during DTX and/or whether/how to align DRX alignment among multiple UEs.

The solution of the present disclosure proposed a mechanism for enabling (re)transmissions with DTX/DRX of the network node. In this solution, the terminal device obtains information indicative of a DTX pattern and/or the DRX pattern of the network node from the network node. The terminal device determines that at least one of scheduling information that is associated with between the terminal device and the network node has a high priority and/or an indication indicates whether the DTX pattern and/or the DRX pattern is to be followed or applied by the terminal device to monitor a downlink control channel associated with the data communication, from the network node and monitors, based on the determination, the downlink control channel regardless of the DTX pattern and/or the DRX pattern of the network node.

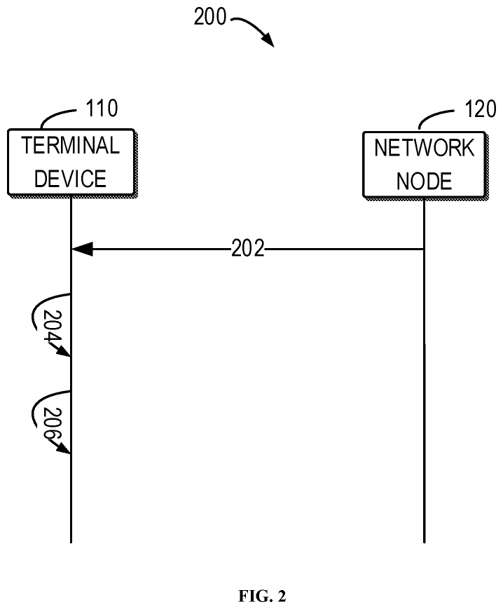

FIG. 2 shows an example signaling diagram of enabling (re)transmissions with DRX/DTX 200 according to some example embodiments of the present disclosure. For the purposes of discussion, the diagram 200 will be discussed with reference to FIG. 1, for example, by using the terminal device 110 and the network node 120.

In some example embodiments of the present disclosure, the network node 120 may provide 202, to the terminal device 110, a DTX pattern and/or the DRX pattern of the network node 120. For example, the network node 120 may transmit a configuration of DTX configured by the network node, which may comprise the DTX pattern and/or the DRX pattern of the network node 120. For example, the configuration of DTX may include DTX parameters such as the length of a DTX period, the duty cycle and the start of a DTX period. For another example, the configuration of DTX may further include PDCCH occasions which the terminal device should not monitor. In some scenarios, the network node 120 may provide the DTX pattern and/or the DRX pattern of the network node 120 via a dedicated signaling. In some other scenarios. the network node 120 may provide the DTX pattern and/or the DRX pattern of the network node 120 via a common signaling.

In the case where the DTX pattern and/or the DRX pattern of the network node 120 is obtained, the terminal device 110 may determine 204 whether the DTX pattern and/or the DRX pattern of the network node 120 should be followed or applied by the terminal device 110 for monitoring a DL channel, e.g., a DL control channel, such as Physical Downlink Control Channel (PDCCH).

In some example embodiments, if the terminal device 110 determines that the scheduling information used for data commination between the terminal device 110 and the network node 120 has a high priority, the terminal device 110 may monitor 206 the DL control channel regardless of the DTX pattern and/or the DRX pattern of the network node. For example, the scheduling information may comprise an UL grant or a DL assignment.

In some embodiments, the terminal device 110 may monitor the DL control channel for a retransmission of at least part of the data communication, for which the scheduling information was used. For example, in a case where the data commutation has the low latency requirement, too much delay for its retransmission may be unacceptable. In some other embodiments, the terminal device 110 may monitor the DL control channel for a new transmission. Substantially, the network node 120 may decide whether the PDDCH monitored by the terminal device 110 is used to provide scheduling information for a retransmission or a new transmission.

Whether the scheduling information, i.e., the UL grant and/or the DL assignment has a high priority may be determined based on various ways.

For example, for the uplink grant, the priority of the UL grant may be determined based on priorities of one or more logical channels (LCHs). The one or more LCHs may be mapped to the UL grant based on Logical Channel Prioritization (LCP) function and, in some examples, LCP restrictions may be applied. A LCH mappable to the UL grant may be referred to as the LCH is allowed to be transmitted via the UL grant. That is, if a LCH mappable to the UL grant has a high priority, the UL grant may also be of high priority.

As an option, if a highest priority LCH configured for the terminal device 110 is mappable to the UL grant, the UL grant may be of high priority.

As another option, if the priority of the LCH mappable to the UL grant satisfies a threshold priority, e.g., the priority of the LCH configured for the terminal device 110 exceeds or is equal to a threshold priority, the UL grant may be of high priority.

As another option, if no LCH with priority lower than or equal to a threshold priority is mappable to the UL grant, the UL grant may be of high priority.

It is also possible that if the LCH mappable to the UL grant belongs to one or more specific Logical Chanel Groups (LCGs), the UL grant may be of high priority.

In some other embodiments, if the UL grant is a grant used for retransmission or is a retransmission grant, the UL grant may be of high priority.

In some other embodiments, the UL grant may also be indicated as being of high priority. For example, if the UL grant is assigned with a high priority status by the network node 120, the UL grant may be of high priority. For example, the network node 120 may assign a high priority status for a grant, e.g., for a configured grant. In case the terminal device 110 transmits on the configured grant, the UL grant may be determined to have high priority.

Alternatively, if a priority indicator in Downlink Control Information (DCI) indicates a high priority for the UL grant, the UL grant may be of high priority. It is to be understood that the priority indicator in the DCI may also indicate a high priority for the DL assignment. If so, the DL assignment may be of high priority. For example, the priority indicator for indicating the high priority for the UL grant or the DL assignment may be an existing indication or a new indication whereas the new indication may have more granularity.

Furthermore, it is also possible that some medium access control-control elements (MAC-CEs), such as a configured grant confirmation MAC-CE or a multiple entry configured grant confirmation MAC-CE may be associated with a high priority of the UL grant. For example, if the configured grant confirmation MAC-CE or the multiple entry configured grant confirmation MAC-CE is transmitted in the UL grant upon reception of Configured Grant activation command, the UL grant is determined to have high priority.

In some example embodiments of the present disclosure, the terminal device 110 may determine whether the DTX pattern and/or the DRX pattern of the network node is to be followed or applied for monitoring the DL control channel based on an explicit indication.

For example, the terminal device 110 may receive, from the network node, an indication indicating whether the terminal device 110 should follow the DTX pattern and/or the DRX pattern of the network node 120 for its PDCCH monitoring, for example, for possible new transmission or re-transmission UL grant/DL assignment reception. If the indication indicating that the DTX pattern and/or the DRX pattern of the network node 120 is not to be followed or applied for the PDCCH monitoring, the terminal device 110 may monitor the PDCCH regardless of the DTX pattern and/or the DRX pattern of the network node 120. For example, the indication may be carried in a DCI, e.g., DCI providing an UL grant/DL assignment, MAC CE, or RRC signaling.

Alternatively, or additionally, the terminal device 110 may monitor the PDCCH regardless of the DTX pattern and/or the DRX pattern of the network node 120 for a pre-defined/configured period of time. After that, the terminal device 110 may retain to follow the DTX pattern and/or the DRX pattern of the network node 120. For example, the pre-defined/configured period of time may be determined based on a timer. For example, the timer may be started when the scheduling information has a high priority or alternatively a pre-defined period after the scheduling information that has a high priority is received. For an alternative example, the pre-defined/configured period of time may be determined based on a received scheduling information. For example, after receiving a scheduling information with high priority, the pre-defined/configured period of time may be started, whereas when receiving the next scheduling information, the pre-defined/configured period of time may be determined to end.

Alternatively, or additionally, if the terminal device 110 monitors the PDCCH regardless of the DTX pattern and/or the DRX pattern of the network node 120, a retransmission timer, e.g., drx-RetransmissionTimerUL or drx-RetransmissionTimerDL, may be started while the monitoring begins.

For example, the retransmission timer may be started after an expiry of a round trip time (RTT) timer, e.g., drx-HARQ-RTT-TimerUL or drx-HARQ-RTT-TimerDL at a first transmission occasion on the downlink control channel, i.e., the first PDCCH occasion, that does not overlap with the DTX of the DTX pattern and/or the DRX pattern of the network node 120.

Alternatively, or additionally, the retransmission timer e.g., drx-RetransmissionTimerUL/DL, may be scaled based on the DTX pattern and/or the DRX pattern, to ensure a same number of transmission occasions on the downlink control channel i.e., a same number of PDCCH occasions, within a duration of the retransmission timer with that in a non-DTX pattern and/or a non-DRX pattern.

Alternatively or additionally, the retransmission timer may also be restarted after expiration. For example, the retransmission timer e.g., drx-RetransmissionTimerUL/DL, may be restarted after an expiry of the retransmission timer if the DTX pattern and/or the DRX pattern expanded through a duration of the retransmission timer. As another option, the retransmission timer may be restarted after an expiry of the retransmission timer if only a predefined number of transmission occasions on the downlink control channel occurred during the duration of the retransmission timer due to the DTX pattern and/or the DRX pattern.

In this way, a high priority (re)transmissions can be scheduled in a fast manner regardless of the network power saving with DTX/DRX pattern or mode. Furthermore, with the example embodiments of the present disclosure, with the DRX operation, (re)transmissions can be scheduled also faster without a need to wait for the next drx-onDurationTimer start occasion.

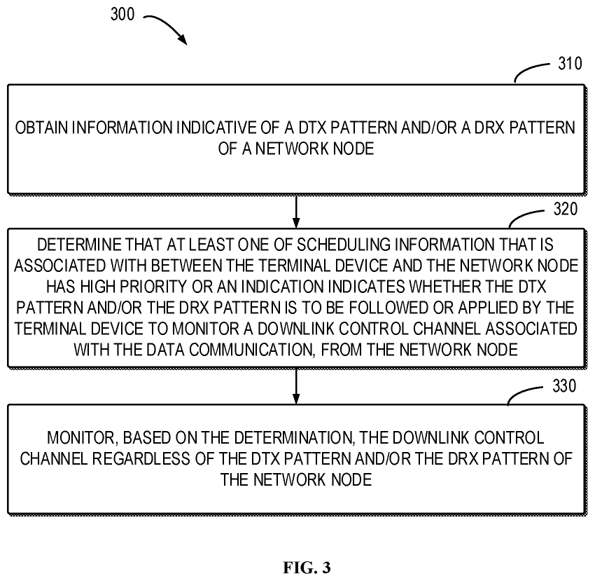

FIG. 3 shows a flowchart of an example method 300 implemented at a terminal device in accordance with some example embodiments of the present disclosure. For the purpose of discussion, the method 400 will be described from the perspective of the terminal device 110 in FIG. 1.

At block 310, the terminal device 110 obtains information indicative of a DTX pattern and/or a DRX pattern of the network node.

At block 320, the terminal device 110 determines that at least one of: scheduling information that is associated with between the terminal device and the network node has a high priority; or an indication indicates whether the DTX pattern and/or the DRX pattern is to be followed or applied by the apparatus to monitor a downlink control channel associated with the data communication, from the network node.

At block 330, the terminal device 110 monitors, based on the determination, the downlink control channel regardless of the DTX pattern and/or the DRX pattern of the network node.

In some example embodiments, the scheduling information used for the data communication comprises an uplink grant and/or a downlink assignment for the apparatus.

In some example embodiments, the terminal device 110 may receive, from the network node, a message indicating corresponding priority information for the uplink grant and/or the downlink assignment; and monitor, based on the corresponding priority information, the downlink control channel regardless of the DTX pattern and/or the DRX pattern of the network node.

In some example embodiments, a priority for the uplink grant is determined based on priorities of one or more LCHs configured for the terminal device.

In some example embodiments, the one or more LCHs are allowed to be transmitted via the UL grant or corresponding to the uplink grant based on one or more LCP restrictions.

In some example embodiments, if a LCH configured for the apparatus satisfying a predefined condition is allowed to be transmitted via the UL grant or corresponding to the uplink grant, the uplink grant is of high priority. In some example embodiments, the predefined condition is satisfied if the LCH has a highest priority within a LCG, or a priority of the LCH satisfies a priority threshold value, or the LCH belongs to one or more specific LCGs.

In some example embodiments, if the uplink grant is a grant used for retransmission associated with the data communication, the uplink grant is of high priority.

In some example embodiments, if the uplink grant is assigned with a high priority status by the network node, the uplink grant is of high priority.

In some example embodiments, if a priority indicator in DCI associated with the data communication indicates high priority for the scheduling information, the scheduling information is of high priority.

In some example embodiments, if a MAC-CE of a configured grant confirmation or a multiple entry configured grant confirmation is transmitted in the uplink grant, the uplink grant is of high priority.

In some example embodiments, the terminal device 110 may receive, the indication indicating whether the DTX pattern and/or the DRX pattern of the network node is to be followed or applied via at least one of DCI, or a MAC-CE, or a RRC signalling.

In some example embodiments, the terminal device 110 may monitor the downlink control channel regardless of the DTX pattern and/or the DRX pattern of the network node based on the determination that the indication indicating the DTX pattern and/or the DRX pattern of the network node is not to be followed or applied by the terminal device.

In some example embodiments, the terminal device 110 may retain to follow or apply the DTX pattern and/or the DRX pattern after the monitoring of the downlink control channel for a pre-defined time period.

In some example embodiments, the terminal device 110 may monitor the downlink control channel when starting a retransmission timer for the data communication.

In some example embodiments, the retransmission timer is started after an expiry of a round trip time timer at a first transmission occasion on the downlink control channel that does not overlap with the DTX of the DTX pattern and/or the DRX pattern.

In some example embodiments, the retransmission timer is scaled, based on the DTX pattern and/or the DRX pattern, to ensure a same number of transmission occasions on the downlink control channel within a duration of the retransmission timer with that in a non-DTX pattern and/or a non-DRX pattern.

In some example embodiments, the retransmission timer is restarted after an expiry of the retransmission timer if the DTX pattern and/or the DRX pattern expanded through a duration of the retransmission timer, or an expiry of the retransmission timer if only a predefined number of transmission occasions on the downlink control channel occurred during the duration of the retransmission timer due to the DTX pattern and/or the DRX pattern.

In some example embodiments, the terminal device 110 may monitor the downlink control channel for retransmissions of at least a part of the data communication or for transmission of a new data communication between the apparatus and the network node.

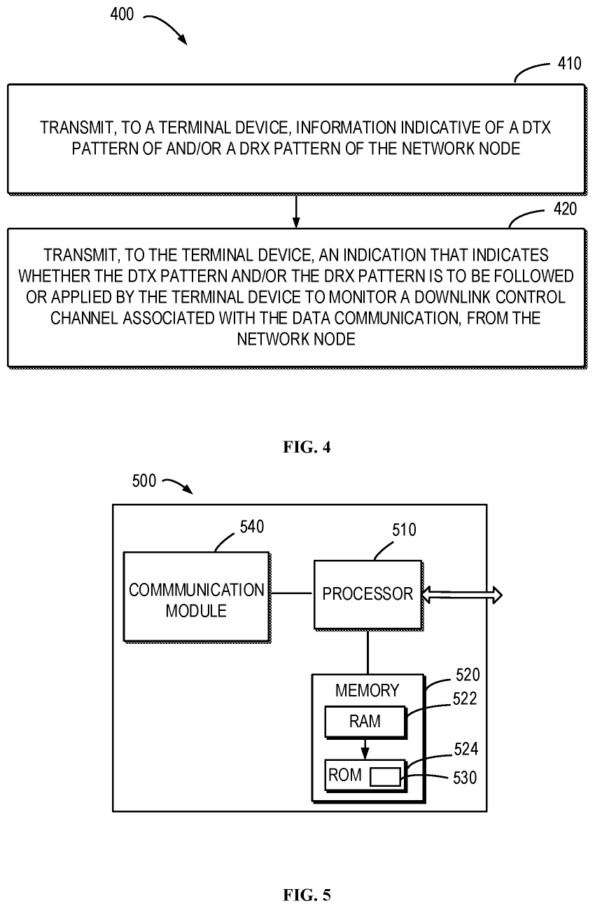

FIG. 4 shows a flowchart of an example method 400 implemented at a network node in accordance with some example embodiments of the present disclosure. For the purpose of discussion, the method 400 will be described from the perspective of the network node 120 in FIG. 1.

At block 410, the network node 120 transmits, to a terminal device, information indicative of a DTX pattern of and/or a DRX pattern of the network node 120.

At block 420, the network node 120 transmits, to the terminal device, an indication indicates whether the DTX pattern and/or the DRX pattern is to be followed or applied by the terminal device to monitor a downlink control channel associated with the data communication, from the network node.

In some example embodiments, the indication is transmitted to the terminal device via at least one of DCI, or a MAC-CE, or a RRC signalling.

In some example embodiments, a first apparatus capable of performing any of the method 300 (for example, the terminal device 110 in FIG. 1) may comprise means for performing the respective operations of the method 300. The means may be implemented in any suitable form. For example, the means may be implemented in a circuitry or software module. The first apparatus may be implemented as or included in the terminal device 110 in FIG. 1.

In some example embodiments, the apparatus comprises means for obtaining information indicative of a DTX pattern and/or a DRX pattern of the network node; and means for determining that at least one of scheduling information that is associated with between the apparatus and the network node has high priority or an indication indicates whether the DTX pattern and/or the DRX pattern is to be followed or applied by the apparatus to monitor a downlink control channel associated with the data communication, from the network node; and means for monitoring, based on the determination, the downlink control channel regardless of the DTX pattern and/or the DRX pattern of the network node.

In some example embodiments, the scheduling information used for the data communication comprises an uplink grant and/or a downlink assignment for the apparatus.

In some example embodiments, the means for monitoring the downlink control channel may comprise means for receiving, from the network node, a message indicating corresponding priority information for the uplink grant and/or the downlink assignment; and monitoring, based on the corresponding priority information, the downlink control channel regardless of the DTX pattern and/or the DRX pattern of the network node.

In some example embodiments, a priority for the uplink grant is determined based on priorities of one or more LCHs configured for the terminal device.

In some example embodiments, the one or more LCHs are allowed to be transmitted via the UL grant or corresponding to the uplink grant based on one or more LCP restrictions.

In some example embodiments, if a LCH configured for the apparatus satisfying a predefined condition is allowed to be transmitted via the UL grant or corresponding to the uplink grant, the uplink grant is of high priority. In some example embodiments, the predefined condition is satisfied if the LCH has a highest priority within a LCG, or a priority of the LCH satisfies a priority threshold value, or the LCH belongs to one or more specific LCGs.

In some example embodiments, if the uplink grant is a grant used for retransmission associated with the data communication, the uplink grant is of high priority.

In some example embodiments, if the uplink grant is assigned with a high priority status by the network node, the uplink grant is of high priority.

In some example embodiments, if a priority indicator in DCI associated with the data communication indicates high priority for the scheduling information, the scheduling information is of high priority.

In some example embodiments, if a MAC-CE of a configured grant confirmation or a multiple entry configured grant confirmation is transmitted in the uplink grant, the uplink grant is of high priority.

In some example embodiments, the apparatus may also comprise means for receiving, the indication indicating whether the DTX pattern and/or the DRX pattern of the network node is to be followed or applied via at least one of DCI, or a MAC-CE, or a RRC signalling.

In some example embodiments, the means for monitoring the downlink control channel may comprise means for monitoring the downlink control channel regardless of the DTX pattern and/or the DRX pattern of the network node based on the determination that the indication indicating the DTX pattern and/or the DRX pattern of the network node is not to be followed or applied by the terminal device.

In some example embodiments, the apparatus may also comprise means for retaining to follow or apply the DTX pattern and/or the DRX pattern after the monitoring of the downlink control channel for a pre-defined time period.

In some example embodiments, the means for monitoring the downlink control channel may comprise means for monitoring the downlink control channel when starting a retransmission timer for the data communication.

In some example embodiments, the retransmission timer is started after an expiry of a round trip time timer at a first transmission occasion on the downlink control channel that does not overlap with the DTX of the DTX pattern and/or the DRX pattern.

In some example embodiments, the retransmission timer is scaled, based on the DTX pattern and/or the DRX pattern, to ensure a same number of transmission occasions on the downlink control channel within a duration of the retransmission timer with that in a non-DTX pattern and/or a non-DRX pattern.

In some example embodiments, the retransmission timer is restarted after an expiry of the retransmission timer if the DTX pattern and/or the DRX pattern expanded through a duration of the retransmission timer, or an expiry of the retransmission timer if only a predefined number of transmission occasions on the downlink control channel occurred during the duration of the retransmission timer due to the DTX pattern and/or the DRX pattern.

In some example embodiments, the means for monitoring the downlink control channel may comprise means for monitoring the downlink control channel for retransmissions of at least a part of the data communication or for transmission of a new data communication between the apparatus and the network node.

In some example embodiments, a first apparatus capable of performing any of the method 400 (for example, the network node 120 in FIG. 1) may comprise means for performing the respective operations of the method 400. The means may be implemented in any suitable form. For example, the means may be implemented in a circuitry or software module. The first apparatus may be implemented as or included in the network node 120 in FIG. 1.

In some example embodiments, the apparatus comprises means for transmitting, to a terminal device, information indicative of a DTX pattern of and/or a DRX pattern of the apparatus; and means for transmitting, to the terminal device, an indication indicates whether the DTX pattern and/or the DRX pattern is to be followed or applied by the terminal device to monitor a downlink control channel associated with the data communication, from the apparatus.

In some example embodiments, the indication is transmitted to the terminal device via at least one of DCI, or a MAC-CE, or a RRC signalling.

FIG. 5 is a simplified block diagram of a device 500 that is suitable for implementing example embodiments of the present disclosure. The device 500 may be provided to implement a communication device, for example, the terminal device 110 or the network node 120 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The instructions of the program 530 may include instructions for performing operations/acts of some example embodiments of the present disclosure. The program 530 may be stored in the memory, e.g., the ROM 524. The processor 510 may perform any suitable actions and processing by loading the program 530 into the RAM 522.

The example embodiments of the present disclosure may be implemented by means of the program 530 so that the device 500 may perform any process of the disclosure as discussed with reference to FIG. 2 to FIG. 4. The example embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

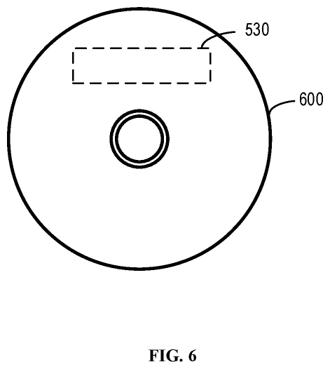

FIG. 6 shows an example of the computer readable medium 600 which may be in form of CD, DVD or other optical storage disk. The computer readable medium 600 has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general-purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
at least one processor; and
at least one memory storing instructions that, when executed by the at least one processor, cause the apparatus at least to:
obtain information indicative of a discontinuous transmission, DTX, pattern of and/or a discontinuous reception, DRX, pattern of a network node;
determine that at least one of:
scheduling information that is associated with data communication between the apparatus and the network node has a high priority; or
an indication indicating whether the DTX pattern and/or the DRX pattern is to be followed or applied by the apparatus to monitor a downlink control channel associated with the data communication, from the network node; and
monitor, based on the determination, the downlink control channel regardless of the DTX pattern and/or the DRX pattern of the network node.

2. The apparatus of claim 1, wherein the scheduling information for the data communication comprises an uplink grant and/or a downlink assignment for the apparatus.

3. The apparatus of claim wherein the apparatus is further caused to:
receive, from the network node, a message indicating corresponding priority information for the uplink grant and/or the downlink assignment; and
monitor, based on the corresponding priority information, the downlink control channel regardless of the DTX pattern and/or the DRX pattern of the network node.

4. The apparatus of claim 2, wherein a priority for the uplink grant is determined based on priorities of one or more logical channels, LCHs configured for the apparatus.

5. The apparatus of claim 4, wherein the one or more LCHs are allowed to be transmitted via the uplink grant or corresponding to the uplink grant based on one or more Logical Channel Prioritization, LCP, restrictions.

6. The apparatus of claim 2, wherein if a LCH configured for the apparatus satisfying a predefined condition is allowed to be transmitted via the uplink grant or corresponding to the uplink grant, the uplink grant is of high priority.

7. The apparatus of claim 6, wherein the predefined condition is satisfied if:
the LCH has a highest priority within a Logical Channel Group, LCG, or
a priority of the LCH satisfies a priority threshold value, or
the LCH belongs to one or more specific Logical Chanel Groups, LCGs.

8. The apparatus of claim 2, wherein if the uplink grant is a grant used for retransmission associated with the data communication, the uplink grant is of high priority.

9. The apparatus of claim 2, wherein if the uplink grant is assigned with a high priority status by the network node, the uplink grant is of high priority.

10. The apparatus of claim 2, wherein if a priority indicator in downlink control information, DCI, associated with the data communication indicates high priority for the scheduling information, the scheduling information is of high priority.

11. The apparatus of claim 2, wherein if a medium access control-control element, MAC-CE, of a configured grant confirmation or a multiple entry configured grant confirmation is transmitted in the uplink grant, the uplink grant is of high priority.

12. The apparatus of claim 1, wherein the apparatus is further caused to:
receive, from the network node, the indication indicating whether the DTX pattern and/or the DRX pattern of the network node is to be followed or applied by the apparatus via at least one of the following:
downlink control information, DCI, or
a medium access control-control element, MAC-CE, or
a Radio Resource Control, RRC, signalling.

13. The apparatus of claim 1, wherein the apparatus is further caused to:
monitor the downlink control channel regardless of the DTX pattern and/or the DRX pattern of the network node based on the determination that the indication indicating the DTX pattern and/or the DRX pattern of the network node is not to be followed or applied by the apparatus.

14. The apparatus of claims 1, wherein the apparatus is further caused to:
retain to follow or apply the DTX pattern and/or the DRX pattern after the monitoring of the downlink control channel for a pre-defined time period.

15. The apparatus of claim 1, wherein the apparatus is further caused to:
monitor the downlink control channel when starting a retransmission timer for the data communication.

16. The apparatus of claim 15, wherein the retransmission timer is started after an expiry of a round trip time timer at a first transmission occasion on the downlink control channel that does not overlap with the DTX pattern and/or the DRX pattern.

17. The apparatus of claim 15, wherein the retransmission timer is scaled, based on the DTX pattern and/or the DRX pattern, to ensure a same number of transmission occasions on the downlink control channel within a duration of the retransmission timer with that in a non-DTX pattern and/or a non-DRX pattern.

18. The apparatus of claims 15-17, wherein the retransmission timer is restarted after one of the following:
an expiry of the retransmission timer if the DTX pattern and/or the DRX pattern expanded through a duration of the retransmission timer, or
an expiry of the retransmission timer if only a predefined number of transmission occasions on the downlink control channel occurred during the duration of the retransmission timer due to the DTX pattern and/or the DRX pattern.

19. (canceled)

20. An apparatus comprising:
at least one processor; and
at least one memory storing instructions that, when executed by the at least one processor, cause the apparatus at least to:
transmit, to a terminal device, information indicative of a discontinuous transmission, DTX, pattern and/or a discontinuous reception, DRX, pattern of the apparatus; and
transmit, to the terminal device, an indication that indicates whether the DTX pattern and/or the DRX pattern is to be followed or applied by the terminal device to monitor a downlink control channel associated with the data communication, from the apparatus.

21. (canceled)

22. A method comprising:
obtaining, at a terminal device, information indicative of a discontinuous transmission, DTX, pattern and/or a discontinuous reception, DRX, pattern of a network node;
determining, by the terminal device, that at least one of:
scheduling information that is associated with data communication between the terminal device and the network node has a high priority; or
an indication indicating whether the DTX pattern and/or the DRX pattern is to be followed or applied by the terminal device to monitor a downlink control channel associated with the data communication, from the network node; and
monitoring, by the terminal device based on the determination, the downlink control channel regardless of the DTX pattern and/or the DRX pattern of the network node.

23-27. (canceled)
